(19) United States
(12) Patent Application Publication
(10) Pub. No.: US 2025/0294585 A1
(43) Pub. Date: Sep. 18, 2025

(54) SIDELINK CONTROL INFORMATION FOR MULTI-CHANNEL COMMUNICATION

(71) Applicant: Telefonaktiebolaget LM Ericsson (publ), Stockholm (SE)

(72) Inventors: Ricardo BLASCO SERRANO, Espoo (FI); Shehzad Ali ASHRAF, Aachen (DE)

(21) Appl. No.: 18/860,308

(22) PCT Filed: Apr. 5, 2023
(86) PCT No.: PCT/SE2023/050318

§ 371 Date: Oct. 25, 2024

Related U.S. Application Data
(60) Provisional application No. 63/335,018, filed on Apr. 26, 2022.

(51) Int. Cl. H04W 72/25; H04L 1/1812

(52) U.S. Cl. CPC H04W 72/25; H04L 1/1812

(57) ABSTRACT

Methods for a first user equipment (UE) configured for sidelink (SL) communication with at least a second UE via a plurality of channels. Such methods include transmitting, in the plurality of channels, a corresponding plurality of sidelink control information (SCI) messages that include reservation of resources in the plurality of channels for SL communication by the first UE. Such methods include transmitting or receiving data via SL communication with the second UE, using at least part of the resources in the plurality of channels that were reserved by the plurality of SCI messages transmitted by the first UE. Other embodiments include complementary methods for the second UE, as well as first and second UEs configured to perform such methods.

### TECHNICAL FIELD

The present disclosure relates generally to wireless communication and more specifically to improving device-to-device (D2D) communication between user equipment (UEs) capable of sidelink (SL) communication using multiple channels.

### BACKGROUND

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases. NR was initially specified in 3GPP Release 15 (Rel-15) and continues to evolve through subsequent releases, such as Rel-16 and Rel-17.

5G/NR technology shares many similarities with fourth-generation Long-Term Evolution (LTE). For example, NR uses CP-OFDM (Cyclic Prefix Orthogonal Frequency Division Multiplexing) in the downlink (DL) from network to user equipment (UE), and both CP-OFDM and DFT-spread OFDM (DFT-S-OFDM) in the uplink (UL) from UE to network. As another example, NR DL and UL time-domain physical resources are organized into equal-sized 1-ms subframes. A subframe is divided into multiple slots of equal duration, with each slot including multiple OFDM-based symbols. Time-frequency resources can be configured much more flexibly for an NR cell than for an LTE cell. For example, rather than a fixed 15-kHz OFDM sub-carrier spacing (SCS) as in LTE, NR SCS can range from 15 to 240 kHz, with greater SCS considered for future NR releases (e.g., in higher frequency bands).

NR also supports carrier aggregation (CA), which was introduced in LTE Rel-10. In CA, the network can configure a “wideband” carrier for the UE based on a number of “component carriers.” In the context of CA, the terms “component carrier” (or CC, for short) and “cell” are often used interchangeably. A primary serving cell (PCell) is defined as the “main” cell serving the wireless device such that both data and control signaling can be transmitted over the PCell, while one or more supplementary or secondary serving cells (SCells) are typically used for transmitting data only. A CA-capable UE can be assigned a PCell (or CC) that is always activated, and one or more SCells (or CCs) that can be activated or deactivated dynamically.

The term “symmetric configuration” refers to when the number of CCs in UL and DL is the same, whereas “asymmetric configuration” refers to when the number of CCs is different. Furthermore, the number of CCs configured within a wideband carrier may be different from the number of CCs seen by a UE. For example, a UE can support more DL CCs than UL CCs, even though the wideband carrier is configured with the same number of UL CCs and DL CCs.

License Assisted Access (LAA) is an LTE feature that uses unlicensed 5-GHz spectrum in combination with licensed spectrum to deliver a performance boost for mobile device users. LAA uses DL carrier aggregation (CA) to combine LTE in licensed and unlicensed bands to provide better data rates and a better user experience. For example, in LAA, the UE's primary cell (PCell) is in a licensed band while the UE's secondary cells (SCells) can be in an unlicensed band. Since LAA operates in the 5-GHz band where Wi-Fi operates, it must be able to co-exist with Wi-Fi by avoiding channels occupied by Wi-Fi users. LAA uses a concept called Listen-before-talk (LBT) that dynamically selects 5-GHz-band channel(s) that is (are) not being used, i.e., a “clear channel.” If no clear channel is available, LAA will share a channel fairly with others. As such, LBT is often referred to as clear channel assessment (CCA).

NR Rel-16 includes a feature similar to LTE LAA, referred to as NR-Unlicensed (NR-U). In contrast to LTE LAA, NR-U supports dual-connectivity (DC) and standalone scenarios in which cooperative licensed spectrum is not available. In such scenarios, medium access control (MAC, e.g., random access) and scheduling procedures on unlicensed spectrum are subject to the LBT failures. This was not the case for LTE LAA, since MAC and scheduling procedures were performed in the licensed spectrum where LBT is unnecessary. Note the terms “shared” and “unlicensed” are used synonymously herein when referring to spectrum, unless stated otherwise. Rel-16 NR-U also supports wideband operation, whereby a UE can perform sensing and transmission over a wideband (i.e., much greater than 20 MHz) that includes multiple LBT bandwidths (or sub-bands).

Sidelink (SL) is a type of device-to-device (D2D) communication in which UEs communicate with each other directly rather than indirectly via a 3GPP RAN. D2D was first introduced in LTE Rel-12, targeting public safety use cases and proximity-based services (ProSe). Subsequently, various extensions have been introduced to broaden the range of use cases that can benefit from D2D technology. For example, D2D extensions in LTE Rel-14 and Rel-15 include supporting vehicle-to-everything (V2X) communication.

3GPP Rel-16 specifies the NR SL interface and targets advanced V2X services, including four primary groups of use cases: vehicles platooning, extended sensors, advanced driving, and remote driving. The advanced V2X services require a new SL in order to meet the stringent requirements in terms of latency and reliability. The NR SL is designed to provide higher system capacity and better coverage, and to allow for extension to support the future development of even more advanced V2X services and other related services.

Broadcast, groupcast, and unicast transmissions are desirable for the services targeted by NR SL. In groupcast (or multicast), the intended receiver of a message consists of only a subset of the possible recipients in proximity to the transmitter, whereas a unicast message is intended for only one recipient in proximity to the transmitter. For example, in the platooning service there are certain messages that are of interest only to platoon members, for which groupcast can be used. Unicast is a natural fit for use cases involving only a pair of vehicles.

Furthermore, NR SL is designed such that it is operable both with and without network coverage and with varying degrees of interaction between the UEs (user equipment) and the RAN, including support for standalone, network-less operation. For example, national security and public safety (NSPS) services often need to operate without (or with partial) RAN coverage, such as during indoor firefighting, forest firefighting, earthquake rescue, sea rescue, etc. Network coverage extension is a crucial enabler in these scenarios.

### SUMMARY

It is expected that 3GPP Rel-18 and later releases will include mechanisms for UE transmission and/or reception on multiple channels, including aggregation of multiple carriers in licensed or unlicensed spectrum and wideband transmission spanning multiple channels in unlicensed spectrum. From a lower layer perspective, the first approach appears as multiple transmissions on separate carriers and the second approach appears as a single transmission. It is expected that these approaches will be applicable for UL, DL, and SL.

Although SL transmissions in the second approach span multiple channels, scheduling and/or reservation information for such SL transmissions is contained within one of these multiple channels. This can cause various problems, issues, and/or difficulties, particularly for UEs that are unable to receive SL transmissions on all of the channels.

An object of embodiments of the present disclosure is to improve D2D communication between UEs capable of SL communication, such as by providing, enabling, and/or facilitating solutions to exemplary problems summarized above and described in more detail below.

Embodiments include exemplary methods (e.g., procedures) for a first UE configured for SL communication with at least a second UE via a plurality of channels.

These exemplary methods can include transmitting, in the plurality of channels, a corresponding plurality of SCI messages that include reservation of resources in the plurality of channels for SL communication by the first UE. These exemplary methods can also include transmitting or receiving data via SL communication with the second UE, using at least part of the resources in the plurality of channels that were reserved by the plurality of SCI messages transmitted by the first UE.

In some embodiments, the plurality of SCI messages include a first SCI message transmitted in a first channel that includes a reservation of resources in the first channel and a second SCI message transmitted in a second channel that includes a reservation of resources in the second channel. In some of these embodiments, the first and second SCI messages have the same format.

In some of these embodiments, the first SCI message includes an indicator of whether a third SCI message is also transmitted in the first channel. Unlike the first and second messages, the third SCI message does not include a reservation of resources for SL communication by the first UE. In addition, these exemplary methods also include selectively transmitting the third SCI message according to the indicator in the first SCI message. In some variants, the third SCI message includes a scheduling assignment for the second UE when the indicator indicates that third SCI message is transmitted, while the first SCI message includes the scheduling assignment for the second UE when the indicator indicates that third SCI message is not transmitted.

In some of these embodiments, the resources reserved by the first SCI message are only in the first channel and the resources reserved by the second SCI message are only in the second channel. In other of these embodiments, the resources reserved by the first SCI message are in the plurality of channels and the resources reserved by the second SCI message are in one of the following: only the second channel, or a subset of the plurality of channels that includes the second channel.

In other of these embodiments, the resources reserved by the first SCI message are in the plurality of channels and the resources reserved by the second SCI message are in the plurality of channels. In other of these embodiments, the plurality of channels also include a third channel, the resources reserved by the first SCI message are in the first and third channels but not the second channel, and the resources reserved by the second SCI message are in the second and third channels but not the first channel.

In some embodiments, the reservation of resources is for one or more of the following associated with a transport block (TB) of data: initial transmission by the first UE, blind retransmission or repetition by the first UE, hybrid ARQ-based retransmission by the first UE, and reception from the second UE.

Other embodiments include exemplary methods (e.g., procedures) for a second UE configured for SL communication with at least a first UE via a plurality of channels. In general, these exemplary methods are complementary to the exemplary methods for a first UE, summarized above.

These exemplary methods can include receiving, in one or more of the plurality of channels, a corresponding one or more SCI messages that include reservation of resources in the plurality of channels for SL communication by the first UE. These exemplary methods can also include, based on the received one or more SCI messages, determining whether the second UE can perform the SL communication with the first UE via the plurality of channels. These exemplary methods can also include, based on determining that the second UE can perform the SL communication with the first UE, receiving or transmitting data via SL communication with the first UE, using at least part of the resources in the plurality of channels that were reserved by the one or more SCI messages received by the second UE.

In some embodiments, the one or more SCI messages received by the second UE include one or more of the following transmitted by the first UE: a first SCI message in a first channel that includes a reservation of resources in the first channel; and a second SCI message in a second channel that includes a reservation of resources in the second channel. For example, the first and second SCI messages can be first stage SCI messages, such as discussed above. In some of these embodiments, the first and second SCI messages have the same format.

In some of these embodiments, determining whether the second UE can perform the SL communication with the first UE via the corresponding one or more channels can include the following operations:
based on receiving only one of the first and second SCI messages, determining that the second UE cannot perform the SL communication via the first and second channels; and
based on receiving both of the first and second SCI messages, determining that the second UE can perform the SL communication via the first and second channels.

In some of these embodiments, these exemplary methods can also include, based on decoding a received one of the first and second SCI messages, refraining from decoding a received other of the first and second messages.

In some of these embodiments, the first SCI message includes an indicator of whether a third SCI message is also transmitted in the first channel. Unlike the first and second messages, the third SCI message does not include a reservation of resources for SL communication by the first UE. In addition, these exemplary methods also include selectively receiving the third SCI message according to the indicator in the first SCI message. In some variants, the third SCI message includes a scheduling assignment for the second UE when the indicator indicates that third SCI message is transmitted, while the first SCI message includes the scheduling assignment for the second UE when the indicator indicates that third SCI message is not transmitted.

In some of these embodiments, the resources reserved by the first SCI message are only in the first channel and the resources reserved by the second SCI message are only in the second channel. In other of these embodiments, the resources reserved by the first SCI message are in the plurality of channels and the resources reserved by the second SCI message are in one of the following: only the second channel, or a subset of the plurality of channels that includes the second channel.

In other of these embodiments, the resources reserved by the first SCI message are in the plurality of channels and the resources reserved by the second SCI message are in the plurality of channels. In other of these embodiments, the plurality of channels also include a third channel, the resources reserved by the first SCI message are in the first and third channels but not the second channel, and the resources reserved by the second SCI message are in the second and third channels but not the first channel.

In some embodiments, the reservation of resources is for one or more of the following associated with a TB of data: initial transmission by the first UE, blind retransmission or repetition by the first UE, hybrid ARQ-based retransmission by the first UE, and transmission by the second UE

Other embodiments include UEs (e.g., wireless devices) configured to perform operations corresponding to any of the exemplary methods described herein. Other embodiments include non-transitory, computer-readable media storing program instructions that, when executed by processing circuitry, configure such UEs to perform operations corresponding to any of the exemplary methods described herein.

These and other embodiments described herein can facilitate SL transmitter UEs to reserve resources in multiple channels when performing multi-channel transmissions, without making any assumptions about bandwidth supported by a SL receiver UE. Embodiments can also facilitate SL receiver UEs to determine type(s) of information to be transmitted in each of the multiple channels and/or how the multiple channels are reserved by the SCI. Moreover, embodiments provide such benefits and/or advantages without requiring additional UE receiver hardware and/or without substantial increases in receiver complexity and/or energy consumption. More generally, embodiments facilitate interoperability of UEs with different SL capabilities.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 shows exemplary NR user plane (UP) and control plane (CP) protocol stacks.

FIG. 2 illustrates a high-level views of an exemplary 5G/NR network architecture.

FIG. 3 shows an exemplary intra-band CA arrangement in which a UE is configured with three CCs in a single frequency band.

FIG. 4 shows an exemplary LTE CCA procedure performed by a UE or network node wanting to transmit on a channel in unlicensed spectrum.

FIG. 5 shows an exemplary arrangement of interfaces between two V2X UEs and a RAN.

FIG. 6 shows three exemplary network coverage scenarios for two UEs and a gNB serving a cell.

FIG. 7 shows an exemplary time-frequency grid for SL communication in a channel.

FIG. 8 illustrates examples of SL resource reservation.

FIGS. 9-10 show exemplary time-frequency grids for SL communication in three channels.

FIG. 11 shows an exemplary time-frequency grid for SL communication in two channels, according to some embodiments of the present disclosure.

FIGS. 12-15 show exemplary time-frequency grids for SL communication in three channels, according to various embodiments of the present disclosure.

FIG. 16 shows a flow diagram of an exemplary method for a first UE (e.g., wireless device), according to various embodiments of the present disclosure.

FIG. 17 shows a flow diagram of an exemplary method for a second UE (e.g., wireless device), according to various embodiments of the present disclosure.

FIG. 18 shows a communication system according to various embodiments of the present disclosure.

FIG. 19 shows a UE according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where a step must necessarily follow or precede another step due to some dependency. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node (or component thereof such as MT or DU), a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), etc. A core network node can also be a node that implements a particular core network function (NF), such as an access and mobility management function (AMF), a session management function (SMF), a user plane function (UPF), a Service Capability Exposure Function (SCEF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without any prefix) can be any type of node that is capable of operating in or with a wireless network (including a RAN and/or a core network), including a radio access node (or equivalent term), core network node, or wireless device. However, the term “node” may be limited to a particular type of node (e.g., radio access node) based on its specific characteristics in any context of use.

Note that the description herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

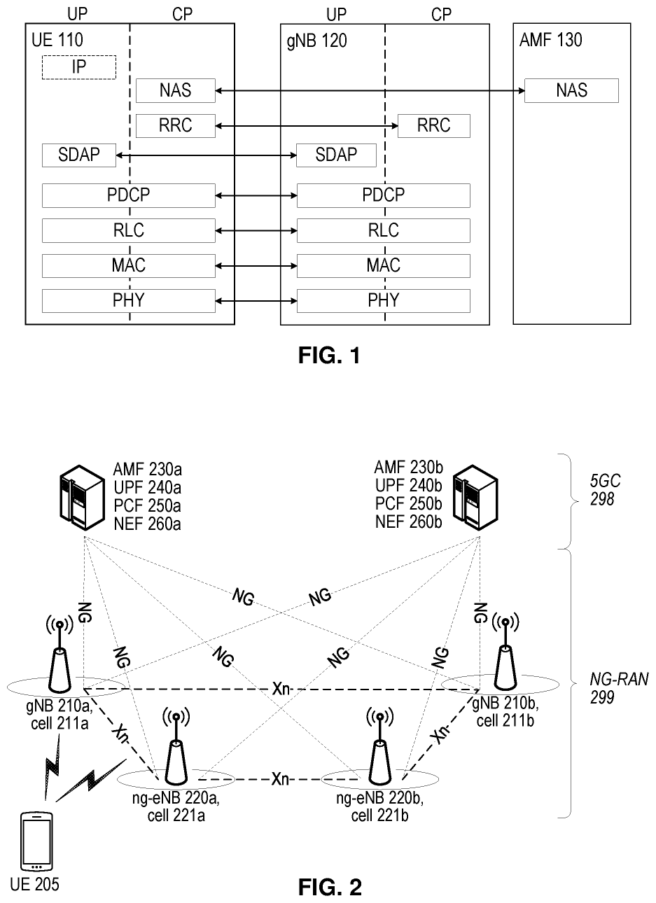

FIG. 1 shows an exemplary configuration of NR user plane (UP) and control plane (CP) protocol stacks between a UE (110), a gNodeB (gNB, 120), and an access and mobility management function (AMF, 130) in the 5G core network (5GC). Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for CP and UP.

On CP side, the non-access stratum (NAS) layer is between UE and AMF and handles UE/gNB authentication, mobility management, and security control. The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and establishes, configures, maintains, and releases DRBs and Signaling Radio Bearers (SRBs) used by UEs. Additionally, RRC controls addition, modification, and release of carrier aggregation (CA) and dual-connectivity (DC) configurations for UEs. RRC also performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on physical DL control channel (PDCCH) for pages from 5GC via gNB. A UE in RRC IDLE state is not known to the gNB serving the cell where the UE is camping. However, NR RRC includes an RRC_INACTIVE state in which a UE is known (e.g., via context) by the serving gNB.

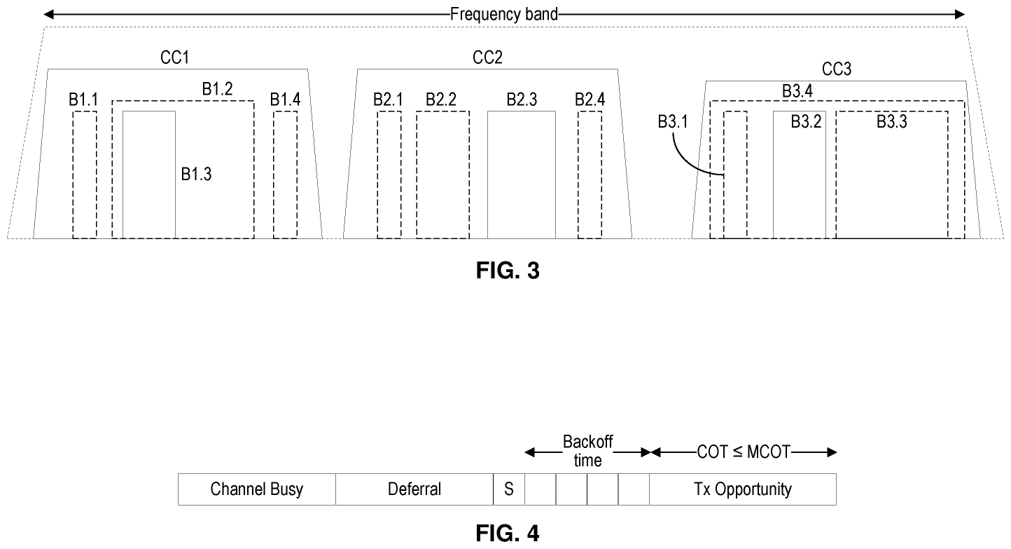

FIG. 2 shows a high-level view of an exemplary 5G network architecture, including a Next Generation Radio Access Network (NG-RAN, 299) and a 5G Core (5GC, 298). As shown in the figure, the NG-RAN can include gNBs (e.g., 210a,b) and ng-eNBs (e.g., 220a,b) that are interconnected with each other via respective Xn interfaces. The gNBs and ng-eNBs are also connected via the NG interfaces to the 5GC, more specifically to an access and mobility management function (AMF, e.g., 230a,b) via respective NG-C interfaces and to a user plane function (UPF, e.g., 240a,b) via respective NG-U interfaces. Moreover, the AMFs can communicate with one or more policy control functions (PCFs, e.g., 250a,b) and network exposure functions (NEFs, e.g., 260a,b).

Each of the gNBs can support the NR radio interface including frequency division duplexing (FDD), time division duplexing (TDD), or a combination thereof. In contrast, each of ng-eNBs can support the LTE radio interface but, unlike conventional LTE eNodeBs (eNBs), connect to the 5GC via the NG interface. Each of the gNBs and ng-eNBs can serve a geographic coverage area including one more cells (e.g., 211a-b and 221a-b). The gNBs and ng-eNBs can also use various directional beams to provide coverage in the respective cells. Depending on the particular cell in which it is located, a UE (205) can communicate with the gNB or ng-eNB serving that cell via the NR or LTE radio interface, respectively.

The gNBs shown in FIG. 2 can include a central (or centralized) unit (CU or gNB-CU) and one or more distributed (or decentralized) units (DU or gNB-DU), which can be viewed as logical nodes. CUs host higher-layer protocols and perform various gNB functions such controlling the operation of DUs, which host lower-layer protocols and can include various subsets of the gNB functions. As such, each of the CUs and DUs can include various circuitry needed to perform their respective functions, including processing circuitry, communication interface circuitry (e.g., for communication via Xn, NG, radio, etc. interfaces), and power supply circuitry. Moreover, the terms “central unit” and “centralized unit” can be used interchangeably, as can the terms “distributed unit” and “decentralized unit.”

A CU connects to its associated DUs over respective F1 logical interfaces. A CU and associated DUs are only visible to other gNBs and the 5GC as a gNB, e.g., the F1 interface is not visible beyond a CU. A CU can host higher-layer protocols such as F1 application part protocol (F1-AP), Stream Control Transmission Protocol (SCTP), GPRS Tunneling Protocol (GTP), Packet Data Convergence Protocol (PDCP), User Datagram Protocol (UDP), Internet Protocol (IP), and Radio Resource Control (RRC) protocol. In contrast, a DU can host lower-layer protocols such as Radio Link Control (RLC), Medium Access Control (MAC), and physical-layer (PHY) protocols.

NR DL and UL physical resources are organized into equal-sized 1-ms subframes. A subframe is further divided into multiple slots of equal duration, with each slot including multiple OFDM-based symbols. An NR slot can include 14 OFDM symbols for normal cyclic prefix and 12 symbols for extended cyclic prefix. A resource block (RB) consists of a group of 12 contiguous OFDM subcarriers for a duration of a 12- or 14-symbol slot. A resource element (RE) corresponds to one OFDM subcarrier during one OFDM symbol interval. An NR slot can also be arranged with various time-division duplexing (TDD) arrangements of UL and DL symbols. These TDD arrangements include:
DL-only (i.e., no UL transmission) slot with transmission late-start in symbol 1;
DL-heavy, with one UL symbol and guard periods before and after the UL symbol to facilitate change of transmission direction;
UL-heavy, with a single UL symbol that can carry DL control information; and
UL-only with transmission on-time start in symbol 0 and the initial UL symbol usable to carry DL control information.

In addition to providing coverage via cells as in LTE, NR networks also provide coverage via “beams.” In general, a downlink (DL, i.e., network to UE) “beam” is a coverage area of a network-transmitted reference signal (RS) that may be measured or monitored by a UE. In NR, for example, RS can include any of the following: synchronization signal/PBCH block (SSB), channel state information RS (CSI-RS), tertiary reference signals (or any other sync signal), positioning RS (PRS), demodulation RS (DMRS), phase-tracking reference signals (PTRS), etc. In general, SSB is available to all UEs regardless of the state of their connection with the network, while other RS (e.g., CSI-RS, DM-RS, PTRS) are associated with specific UEs that have a network connection.

These RS are carried by various REs within DL RBs, which also carry various DL physical channels such as physical DL control channel (PDCCH), physical DL shared channel (PDSCH), physical broadcast channel (PBCH), etc. A UE can also transmit various UL physical channels and signals that are carried within UL RBs, such as physical UL control channel (PUCCH), physical UL shared channel (PUSCH), physical random access channel (PRACH), sounding RS (SRS), etc.

A UE performs measurements on DL RS (e.g., beams) of one or more cells in different RRC states. Each cell measured by a UE may operate on the same carrier frequency as the UE's serving cell (e.g., an intra-frequency carrier) or it may operate on a different carrier frequency than the UE's current serving cell (e.g., non-serving carrier frequency). The non-serving carrier is also referred to as an inter-frequency carrier when the serving and measured cells belong to the same RAT bit different carrier frequencies, or as an inter-RAT carrier if the serving and measured cells belong to different RATs.

Examples of UE cell measurements include cell identification (e.g., PCI acquisition, PSS/SSS detection, cell detection, cell search, etc.), RS Received Power (RSRP), RS Received Quality (RSRQ), secondary synchronization RSRP (SS-RSRP), SS-RSRQ, SINR, RS-SINR, SS-SINR, CSI-RSRP, CSI-RSRQ, received signal strength indicator (RSSI), acquisition of system information (SI) and/or cell global ID (CGI), RS Time Difference (RSTD), UE RX-TX time difference measurement, and Radio Link Monitoring (RLM, including out-of-sync and in-sync detection).

NR also supports the combined use of carrier aggregation (CA) and bandwidth parts (BWPs). For example, a UE can be configured with multiple CCs and up to four DL and four UL BWPs on each CC. On each CC, the UE can have one configured DL BWP and one configured UL BWP active at any given time. Common resource blocks (CRBs) within a carrier bandwidth are numbered from 0 to n-1, where n is the number of RBs comprising the carrier bandwidth. Each BWP configured for a UE may start at CRBi, i=0 . . . n-1, according to the configured BWP size and location.

Additionally, CA can be configured as interband, intraband contiguous, or intraband non- contiguous. Intraband means that the aggregated CCs reside in the same frequency band, and are either contiguous (e.g., adjacent) or non-contiguous (e.g., separated). In contrast, interband CCs reside in different frequency bands.

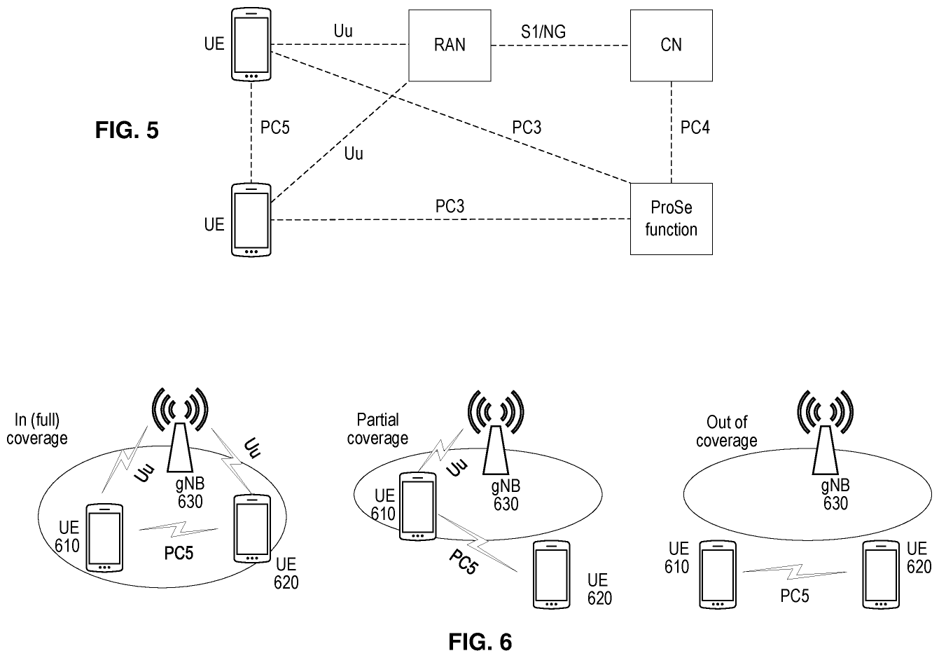

FIG. 3 shows an exemplary intra-band CA arrangement whereby a UE is configured with three CCs in a single frequency band, labeled CCi, i=1-3. The UE is also configured with four BWPs in each CCi, labelled Bj.i, j=1-4. A single BWP is shown as active for each CC, in particular B1.3, B2.3, and B3.2. Inactive BWPs are indicated by dashed lines. Note the arrangement shown in FIG. 3 can apply to DL or UL.

Besides conventional use in licensed (i.e., exclusive) spectrum, NR networks also can operate in unlicensed bands in shared spectrum, referred to generally as NR-U. Operation in unlicensed bands introduces a unique set of rules intended to promote spectrum sharing with otherwise competing transceivers. These rules promote an etiquette or behavior that facilitates spectrum sharing and/or co-existence. According to a common coexistence technique, for a node (e.g., UE or base station) to be allowed to transmit in unlicensed spectrum, it typically needs to perform a listen-before-talk (LBT) or a clear channel assessment (CCA). For example, in the 5 GHz band, the sensing is done over 20-MHz channels. In general, the MAC layer initiates a transmission and requests the PHY layer to initiate the LBT procedure. After completion, the PHY layer indicates the LBT outcome (e.g., success or failure). This procedure can include sensing the medium as idle for a number of time intervals, which can be done in various ways including energy detection, preamble detection, or virtual carrier sensing.

LBT has become well-known and popular due to ubiquitous use by Wireless LANs (also known as “WiFi”), even though most regulatory agencies did not enforce LBT requirements. The introduction of LTE LAA and subsequent definition of LTE LAA regulations ensured LBT functionality was required by all radio transceivers, regardless of whether they were WiFi or LTE LAA. Energy detection (ED) thresholds were defined, simulated, debated, and soon became part of the regulatory specifications to be met by all devices that operate in unlicensed bands.

As an example of energy detection (ED), a channel is assessed to be idle when the received energy or power during the sensing time duration is below a certain ED threshold; otherwise, the channel is considered busy. Regulatory requirements in some regions specify the maximum allowed ED threshold, thus setting a limit on transmitter behavior. An example ED threshold is −72 dBm. In some cases, the ED threshold may depend on the channel bandwidth, e.g., −72 dBm 20 MHz bandwidth, −75 dBm for 10 MHz bandwidth, etc. If the channel is assessed as “busy” then the prospective transmitter (i.e., UE or network node) is required to defer transmission.

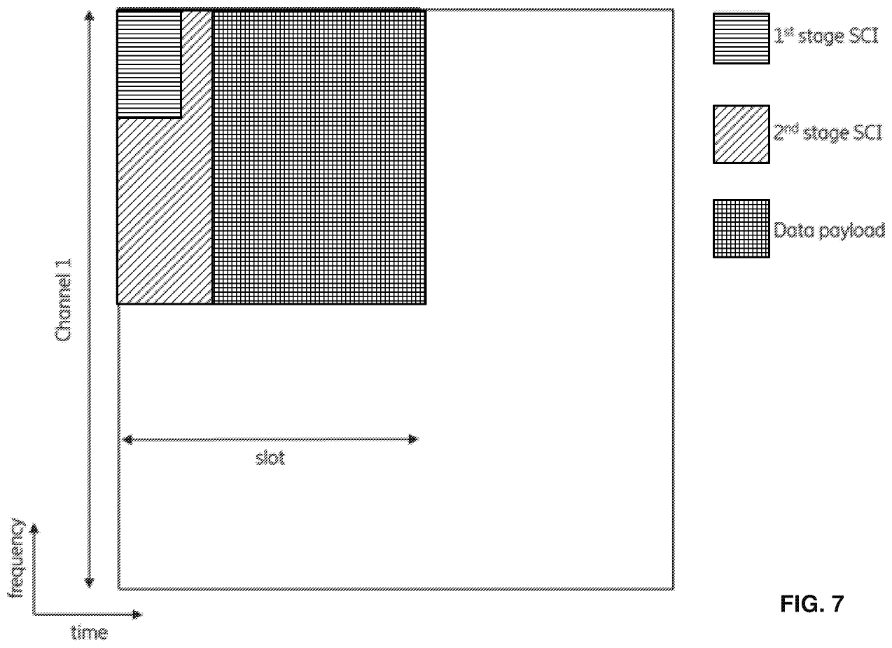

FIG. 4 shows an exemplary LTE CCA procedure performed by a UE or network node wanting to transmit on a channel in unlicensed spectrum. In this procedure, the prospective transmitter initially senses the channel busy for a duration. After a deferral period, the transmitter senses the channel to be idle in the period labelled “s” (for sensing). For example, s=25 μs. After a backoff time following the idle sensing, the transmitter has a transmission opportunity (TXOP) or a channel occupancy time (COT) during which it may transmit a signal, with the COT being less than a maximum COT (MCOT) that depends of regional rules or laws, the sensing period s, etc. For example, a typical COT is 1-10 ms based on a MCOT of 10 ms. The backoff time may be a deterministic value or a probabilistic value (e.g., selected from a random distribution).

It is expected that NR-U will support operation over a wide bandwidth (i.e., much larger than 20 MHz), similar to NR in licensed spectrum. This can be achieved in two different ways: 1) CA with configuration of multiple serving cells (e.g., four with 20 MHz bandwidth each); and 2) configuration of a single wideband serving cell with bandwidth of an integer multiple of 20 MHz (e.g., 80 MHz). These approaches were studied for NR-U in Rel-16, along with potential scheduling constraints and/or feasibility of operating the wideband carrier when LBT is unsuccessful in one or more LBT sub-bands within the wideband carrier. It was assumed that CCA is performed in units of 20 MHz, at least for operation in 5 GHz band.

As used herein, “wideband operation” refers to UE communication within a channel bandwidth larger than 20 MHz in unlicensed (or shared) spectrum, e.g., based on outcome of a CCA procedure. The channel bandwidth includes two or more (i.e., an integer number of) non-overlapping sub-bands, with each sub-band comprising a set of RBs within an ˜20 MHz portion of the channel. The respective sub-bands may be uniform (e.g., of identical bandwidth) but may be separately allocated in UL and DL. Each of the sub-bands may use a different combination of radio-related parameters such as SCS, OFDM symbol duration, cyclic prefix (CP) duration, etc.

As briefly mentioned above, 3GPP Rel-16 specifies the NR sidelink (SL) interface and targets advanced V2X services including use cases such as vehicles platooning, extended sensors, advanced driving, and remote driving. The advanced V2X services require a new SL to meet service requirements of low latency and high reliability. The NR SL is designed to provide higher system capacity and better coverage, and to allow for extension to support the future development of even more advanced V2X services and other related services.

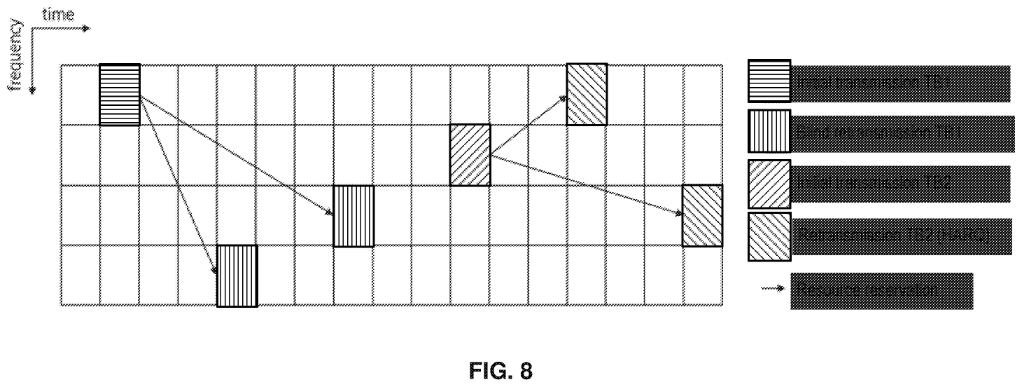

In general, a V2X UE can support unicast communication via the uplink/downlink radio interface (also referred to as “Uu”) to a 3GPP RAN, such as the LTE Evolved-UTRAN (E-UTRAN) or the NG-RAN. A V2X UE can also support SL unicast over the PC5 interface. FIG. 5 shows an exemplary arrangement of interfaces between two V2X UEs and a RAN. In addition to Uu and PC5 interfaces, the V2X UEs can communicate with a ProSe (PROximity-based SErvices) network function (NF) via respective PC3 interfaces. Communication with the ProSe NF requires a UE to establish a connection with the RAN, either directly via the Uu interface or indirectly via PC5 and another UE's Uu interface. The ProSe function provides the UE various information for network related actions, such as service authorization and provisioning of PLMN-specific information (e.g., security parameters, group IDs, group IP addresses, out-of-coverage radio resources, etc.).

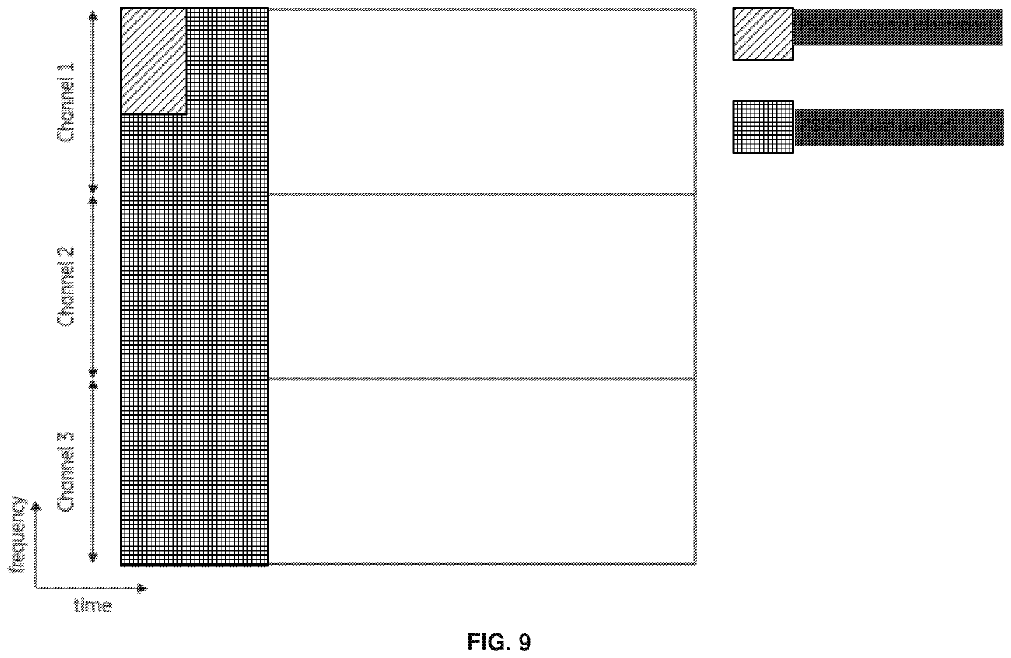

FIG. 6 shows three exemplary network coverage scenarios for two UEs (610, 620) and a gNB (630) serving a cell. In the full coverage scenario (left), both UEs are in the coverage of the cell, such that they both can communicate with the gNB via respective Uu interfaces and directly with each other via the PC5 interface. In the partial coverage scenario (center), only one of the UEs is in coverage of the cell, but the out-of-coverage UE can still communicate with the gNB indirectly via the PC5 interface with the in-coverage UE. In the out-of-coverage scenario, both UEs can only communicate with each other via the PC5 interface.

In general, the term “SL standalone” refers to direct communication between two SL-capable UEs (e.g., via PC5) in which source and destination are the UEs themselves. In contrast, the term “SL relay” refers to indirect communication between a network node and a remote UE via a first interface (e.g., Uu) between the network node an intermediate (or relay) UE and a second interface (e.g., PC5) between the relay UE and the remote UE. In this case the relay UE is neither the source nor the destination.

In general, an “out-of-coverage UE” is one that cannot establish a direct connection to the network and must communicate via either SL standalone or SL relay. UEs that are in coverage can be configured by the network (e.g., gNB) via RRC signaling and/or broadcast system information, either directly (via Uu interface) or indirectly (via PC5 interface and relay UE Uu interface). Out-of-coverage UEs rely on a (pre-)configuration available in their SIMs. These pre-configurations are generally static but can be updated by the network when a UE is in coverage. A “peer UE” refers to a UE that can communicate with the out-of-coverage UE via SL standalone or SL relay (in which case the peer UE is also a relay UE).

NR SL also includes the following new physical channels and RS:
PSSCH (Physical SL Shared Channel, SL version of PDSCH): PSSCH is transmitted by a SL transmitter UE, and conveys SL, SIBs for RRC configuration, and a part of the SL control information (SCI, SL version of DL control information).
PSFCH (Physical SL feedback channel): The PSFCH is transmitted by a SL receiver UE for unicast and groupcast, and conveys one bit information over one RB for HARQ ACK or NACK. In addition, CSI is carried in a MAC control element (CE) over PSSCH instead of via PSFCH.
PSCCH (Physical SL Common Control Channel, SL version of PDCCH): When traffic to be sent to a receiver UE arrives at a transmitter UE, it should first send the PSCCH to convey a part of SCI to be decoded by any UE for channel sensing purpose. This part of SCI includes reserved time-frequency resources for transmissions, DMRS pattern and antenna port, etc.
SL Primary/Secondary Synchronization Signal (S-PSS/S-SSS): SL primary and secondary synchronization signals (S-PSS and S-SSS, respectively) are supported similar to DL PSS/SSS. By detecting S-PSS and S-SSS, a UE is able to identify the SL synchronization identity (SSID) of the sending UE (called “synchronization source”) and its associated characteristics. A process of acquiring timing and frequency synchronization and UE SSIDs is called initial cell search. Note that the UE sending S-PSS/S-SSS may not be necessarily involved in other SL transmissions. There are two S-PSS sequences and 336 S-SSS sequences, forming a total of 672 SSIDs in a cell.
Physical SL Broadcast Channel (PSBCH): PSBCH is transmitted along with the S-PSS/S-SSS as a synchronization signal/PSBCH block (SSB). The SSB has the same numerology as PSCCH/PSSCH on that carrier, and should be transmitted within the bandwidth of the configured bandwidth part (BWP). PSBCH conveys synchronization- related information such as direct frame number (DFN), indication of the slot and symbol level time resources for SL transmissions, in-coverage indicator, etc. SSB is transmitted every 160 ms.
DMRS, PT-RS, CSI-RS: These RS supported by NR DL are also supported on NL SL, including that PT-RS is only applicable for transmissions in frequency range 2 (FR2, e.g., above 6 GHz). As mentioned above, unlike DCI on PDCCH, only a first part (or stage) of SCI is sent on PSCCH. This first stage is used for channel-sensing purposes and can be read by all UEs. The second stage is sent on PSSCH and includes scheduling and control information such as an 8-bit source ID, 16-bit destination ID, new data indicator (NDI), redundancy version (RV), and HARQ process ID. This second part can be decoded only by the intended receiver UE.

Radio resources for SL communication are organized into an SL resource pool spanning both time and frequency domains. In the time domain, the SL resource pool consists of NR slots indexed in an ascending order from zero to a maximum index value. Once this maximum index is reached, the slot indexing is repeated starting again from zero.

Two types of resource allocation modes are supported for NR SL between UEs. In NR SL resource allocation mode 1, all SL transmissions between UEs are scheduled by the network (e.g., a serving gNB) using a configured grant or a dynamic grant, which are described below.

When the traffic to be sent over SL arrives at a transmitter UE, this UE launches a four-message procedure to request SL resources from a gNB: UL scheduling request (SR), DL grant for buffer status report (BSR), UL BSR, and DL grant for data comprising BSR. During the resource request procedure, a gNB may allocate a SL radio network temporary identifier (SL-RNTI) to the transmitter UE. If a SL resource request is granted, the gNB indicates the resource allocation for PSCCH and the PSSCH in DCI on PDCCH with a CRC scrambled with the SL-RNTI. When a transmitter UE receives such a DCI, it UE can obtain the grant only by descrambling the CRC using the assigned SL-RNTI. A transmitter UE then indicates the time-frequency resources and the transmission scheme of the allocated PSSCH in the PSCCH, and launches PSCCH and PSSCH on the resources allocated for SL transmissions. A transmitter UE can only transmit a single TB on a grant obtained from a gNB, making dynamic grants suitable only for traffic with loose latency requirements.

For the traffic with a strict latency requirement, performing the four-message exchange procedure to request SL resources induces unacceptable latency. Thus, prior to anticipated traffic arrival, a transmitter UE may request a set of resources via the four-message exchange procedure mentioned above. The gNB can reserve periodic SL resources according to the request and convey this to the UE in a SL configured grant, similar to an UL configured grant. When the anticipated traffic arrives, the transmitter UE can launch the PSCCH and the PSSCH during the next occasion of the resources of the configured grant. This process is also known as grant-free transmission.

The network (e.g., gNB) can provide a UE with SL configured grant via RRC. SL configured grants typically allocate resources having a periodic, semi-persistent pattern. Two types of configured SL grants are available, i.e., types 1 and 2. In type 2, the network can activate/deactivate the RRC-configured grant using DCI signaling. In other cases, the network may select the resources used for transmission but may give the transmitting SL UE some freedom to select some of the transmission parameters, possibly with some restrictions

In SL resource allocation mode 2, the resource allocation is performed by UE itself, e.g., autonomously based on sensing the carrier/resource pool for availability. In particular, the UE determines SL resource pool(s) by decoding sidelink control information (SCI) received from other UEs and/or by energy sensing, and selects a set of idle/available resources to use for its transmission of PSCCH and PSSCH. In this mode, there may be no intervention by the network (e.g., out of coverage, unlicensed carriers without a network deployment, etc.) or very minimal intervention by the network (e.g., configuration of pools of resources, etc.).

Note that Mode 1 and Mode 2 only describe the behavior of a UE when acting as a SL transmitter. A SL receiver UE behaves the same regardless of SL transmitter mode. Moreover, signals used by SL transmitters operating in Mode 1 and Mode 2 transmitters are identical.

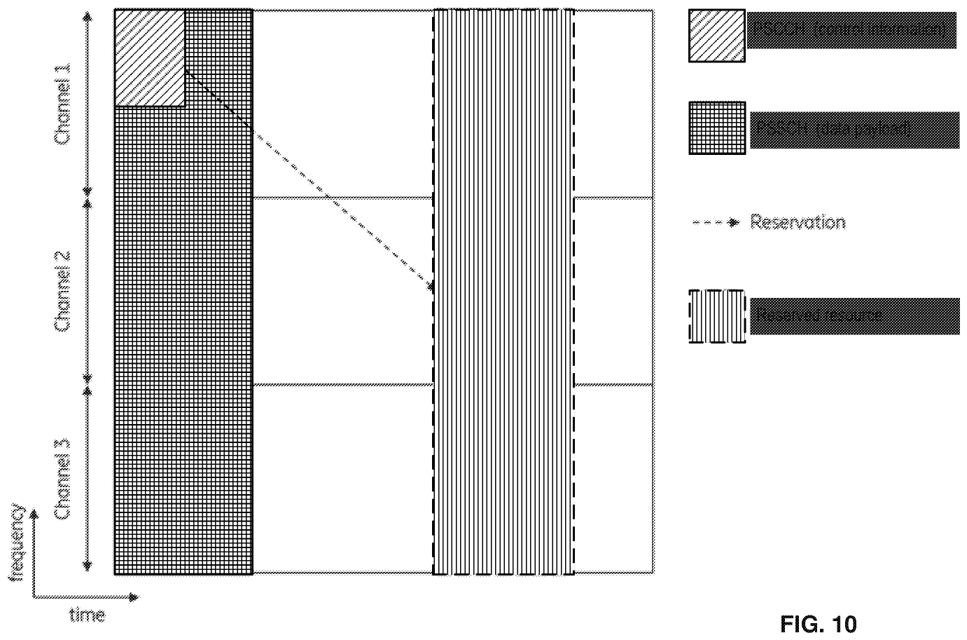

FIG. 7 shows an exemplary time-frequency grid for SL communication in a channel (labelled “Channel 1”). In particular, the first stage of SCI is carried by PSCCH in a first set of time-frequency resources, the second stage of SCI is carried by PSSCH in a second set of time-frequency resources, and the data payload scheduled by SCI is carried in a third set of time-frequency resources. For example, the SCI carries a scheduling assignment (SA) for receiving the data payload.

To further minimize the latency of the HARQ ACK/NACK feedback and subsequent retransmissions, the transmitter UE may also reserve PSCCH/PSSCH resources for retransmissions. To improve probability of successful one-shot transport block (TB) decoding and thereby reduce retransmissions, the transmitter UE may repeat a TB transmission prior to receiving HARQ feedback—a mechanism known as blind retransmission. Thus, when traffic arrives at a transmitter UE, it should select resources for PSSCH associated with PSCCH for initial transmission and blind retransmissions, and PSSCH associated with the PSCCH for retransmissions.

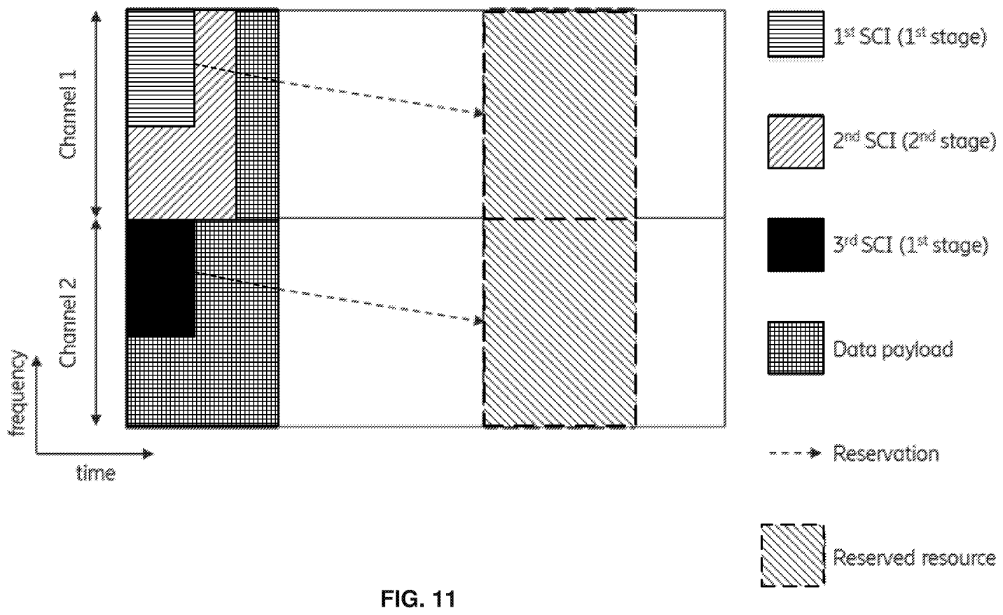

Every PSSCH transmission and can reserve for up to two retransmissions for the same TB. In addition, the same first stage SCI can reserve the same radio resources (i.e., 1-3 RBs) for transmission of a (single) different TB. FIG. 8 illustrates examples of SL resource reservation for non-periodic TB initial transmissions, blind retransmissions, and retransmissions due to HARQ feedback.

It is important to note that, although the SL transmitter UE may select resources for transmission of multiple TBs, only a small subset of them are reserved at a time. In other words, the SL transmitter UE reserves its selected resources in steps. Whether the resources reserved for retransmission of a TB are used or not typically depends on SL HARQ feedback. This is described in the following section.

Since each SL transmitter UE autonomously selects resources in mode 2 as described above, there is a need to prevent different transmitter UEs from selecting the same resources. One mode-2 resource selection procedure is based on a channel sensing technique that involves measuring RSRP on different subchannels. This technique requires knowledge of DMRS power levels for different UEs on PSSCH or PSCCH, depending on the configuration. This information is known only after receiving SCI from all other UEs, and adds to the overall complexity of this channel sensing and selection technique.

3GPP document RP-213678 discusses NR SL evolution in 3GPP Rel-18. An objective listed in this document is to study and specify SL support in unlicensed spectrum for both mode 1 and mode 2, with Uu operation for mode 1 being limited to licensed spectrum only. This document also specifies the following:
Channel access mechanisms from NR-U shall be reused for SL unlicensed operation, but that it should be assessed whether SL resource reservation in Rel-16/Rel-17 is applicable to SL unlicensed operation within the boundaries of unlicensed channel access mechanism and operation. However, there are no specific enhancements for Rel-17 resource allocation mechanisms and if the existing NR-U channel access framework does not support the required SL-U functionality, 3GPP working groups (WGs) will make appropriate recommendations for RAN approval.
Physical channel design framework: Required changes to NR SL physical channel structures and procedures to operate on unlicensed spectrum. Existing NR SL and NR-U channel structure shall be reused as the baseline.
No specific enhancements for existing NR SL feature.
The study should focus on frequency range 1 (FR1) unlicensed bands (n46 and n96/n102).

It is expected that channel access mechanisms similar to those discussed above for NR-U need to be introduced for SL unlicensed operation (SL-U). For these types of channel access mechanisms, a SL UE may need to perform LBT before a SL transmission to another UE.

It is expected that 3GPP Rel-18 and later releases will include mechanisms for UE transmission and/or reception on multiple channels, including aggregation of multiple carriers in licensed or unlicensed spectrum and wideband transmission spanning multiple channels in unlicensed spectrum. From a lower layer perspective, the first approach appears as multiple transmissions on separate carriers and the second approach appears as a single transmission. It is expected that these approaches will be applicable for UL, DL, and SL.

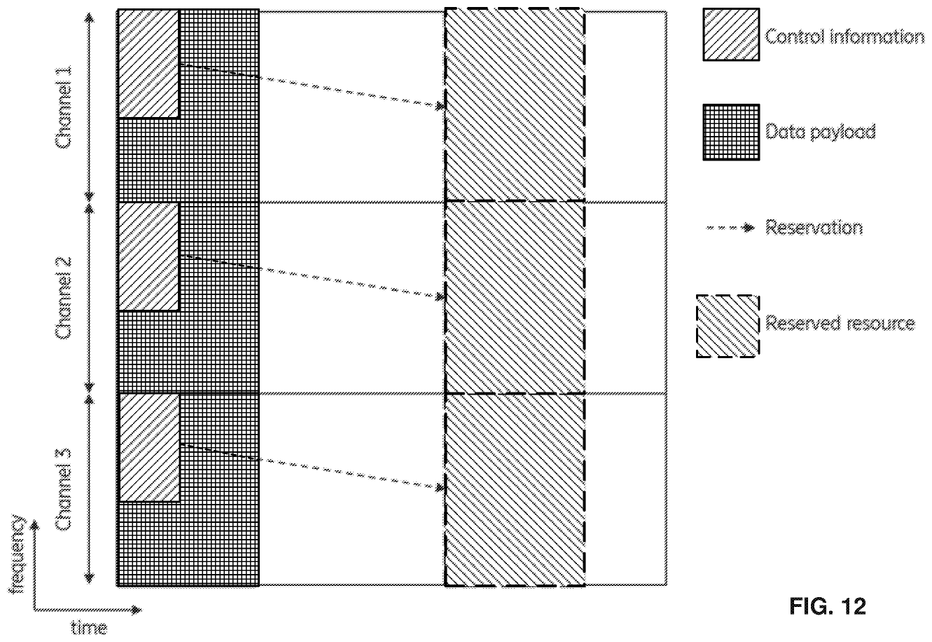

FIG. 9 shows an exemplary time-frequency grid for SL communication in three channels (labelled 1-3). In particular, PSCCH carrying control information (e.g., SCI) is transmitted in a first set of time-frequency resources in Channel 1, and PSSCH containing data payload is transmitted in a second set of time-frequency resources that span Channels 1-3.

Although SL transmissions in the second approach (e.g., FIG. 9) span multiple channels, scheduling and/or reservation information for such SL transmissions is contained within one of these multiple channels. FIG. 10 shows another exemplary time-frequency grid for SL communication in three channels (labelled 1-3). In this arrangement, PSCCH carrying control information (e.g., SCI) is transmitted in a first set of time-frequency resources in Channel 1. The control information carries a reservation of resources in Channels 1-3. Note that each of Channels 1-3 shown in FIG. 10 can be in licensed or unlicensed spectrum. A component carrier in CA is an example of a channel in licensed spectrum.

The arrangement shown in FIG. 10 can cause various problems, issues, and/or difficulties, particularly for UEs that are unable to receive SL transmissions on all of the multiple channels. For example, a SL receiver UE that can only receive on Channel 2 and/or 3 will miss the PSCCH carrying the reservation of resources that is transmitted on Channel 1. Consequently, the SL receiver UE is unaware of the SL transmitter UE's intended future SL transmissions on Channels 2 and/or 3. If the SL receiver UE incorrectly believes that the reserved resources in Channel 2 and/or 3 are available, the SL receiver UE may try to reserve these resources for its own transmissions, resulting in a collision. On the other hand, forcing SL receiver UEs to receive on all channels of a wideband can increase cost, complexity, and/or energy consumption of such devices.

Accordingly, embodiments of the present disclosure provide flexible and efficient techniques for a SL transmitter UE to transmit, in multiple channels, SCI carrying reservation of resources in the multiple channels for subsequent transmissions. As an example, the reservation information is transmitted (e.g., as first stage SCI) on every channel spanned by the subsequent transmissions while scheduling information (e.g., second stage SCI) is transmitted in only one of the channels spanned by the subsequent transmission (e.g., a main channel, a starting channel, a channel with a lowest/highest frequency, etc.).

Embodiments can provide various benefits, advantages, and/or solutions to problems described herein. For example, embodiments facilitate SL transmitter UEs to reserve resources in multiple channels when performing multi-channel transmissions, without making any assumptions about the bandwidth supported by a SL receiver UE. As another example, embodiments facilitate SL receiver UE determination of type(s) of information to be transmitted in each of the multiple channels and/or how the multiple channels are reserved by the SCI. More specifically, embodiments enable a SL receiver UE to determine future utilization of resources in one or more channels, regardless of whether previous transmissions (e.g., by other SL transmitter UEs) have been limited to these channels or have occupied other channels (e.g., to which the SL receiver UE is not listening). Embodiments provide such benefits and/or advantages without requiring additional UE receiver hardware and/or without substantial increases in receiver complexity and/or energy consumption. More generally, embodiments facilitate interoperability of SL UEs with different SL capabilities.

Embodiments are described below in the context of a SL transmitter UE performing a SL transmission of control information that occupies two or more channels. Based on the control information, the SL transmitter UE reserves resources for a future retransmission in some of or all the channels. Although various embodiments are described separately, skilled persons will recognize that various combinations of the described embodiments may provide advantages and/or benefits.

In some embodiments, the SL transmitter UE transmits different types of control information on different ones of multiple channels. For example, two types of control information are transmitted in a first channel (e.g., a main channel, a starting channel, a channel with a lowest/highest frequency, etc.):
First SCI conveying scheduling information that includes reservation information (e.g., time/frequency resource assignment, resource reservation period, priority, etc.). For example, the first SCI can be a first stage SCI of an appropriate SCI format (e.g., 1 or 1-A).
Second SCI conveying additional control information that excludes reservation information. For example, the second SCI can be a second stage SCI of an appropriate SCI format (e.g., 2 or 2-A).

Likewise, the SL transmitter UE transmits only one type of control information in a second channel, i.e., any channel that is not the first channel. As a more specific example, the SL transmitter UE transmits third SCI that conveys scheduling information that includes reservation information (e.g., time/frequency resource assignment, resource reservation period, priority, etc.). For example, the third SCI can be a first stage SCI of an appropriate SCI format (e.g., 1 or 1-A). Note that the third SCI can have the same format as the first SCI, but different content.

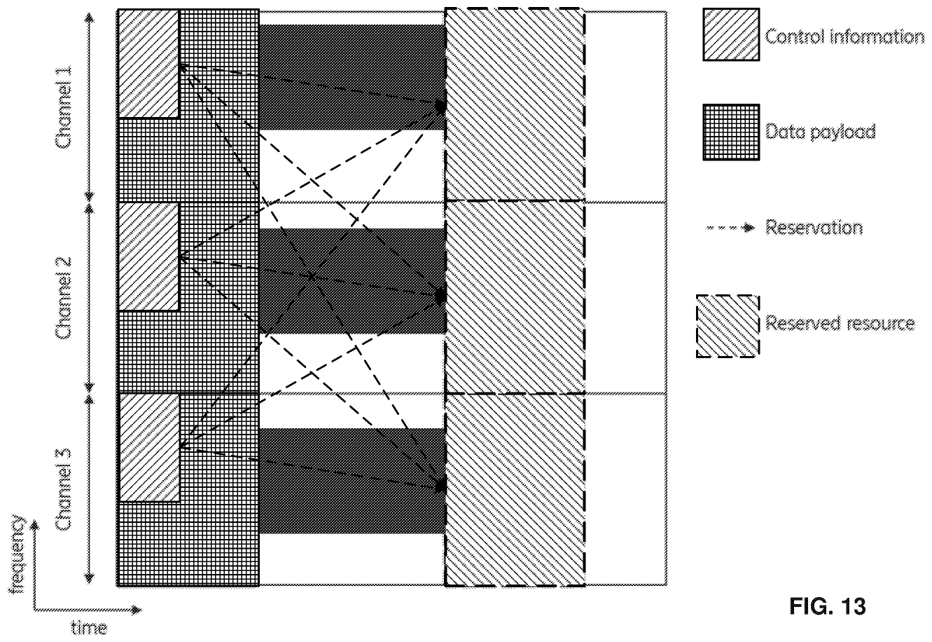

FIG. 11 shows an exemplary time-frequency grid for SL communication in two channels (labelled 1-2), in accordance with these embodiments. In this arrangement, first SCI is transmitted in a first set of time-frequency resources in Channel 1 and second SCI is transmitted in a second set of time-frequency resources in Channel 1. The first SCI carries a reservation of resources in Channel 1. Additionally, a third SCI is transmitted in a third set of time-frequency resources in Channel 2, and carries a reservation of resources in Channel 2.

In some of these embodiments, the first SCI (e.g., first stage SCI) indicates whether the second SCI (e.g., second stage SCI) is present. In other words, the first SCI indicates whether it carries reservation information and a scheduling assignment or only carries reservation information. In the context of the example shown in FIG. 11, a SL receiver UE that receives only on Channel 2 may determine based on the third SCI that this is a multi-channel transmission that cannot be decoded based on the signals received on Channel 2 alone. Likewise, a SL receiver UE that receives only on Channel 1 may determine based on the first SCI that this is a multi-channel transmission that cannot be decoded based on the signals received on Channel 1 alone. However, a SL receiver UE that receives on Channels 1 and 2 may determine based on the first and third SCIs that this is a multi-channel transmission that can be decoded.

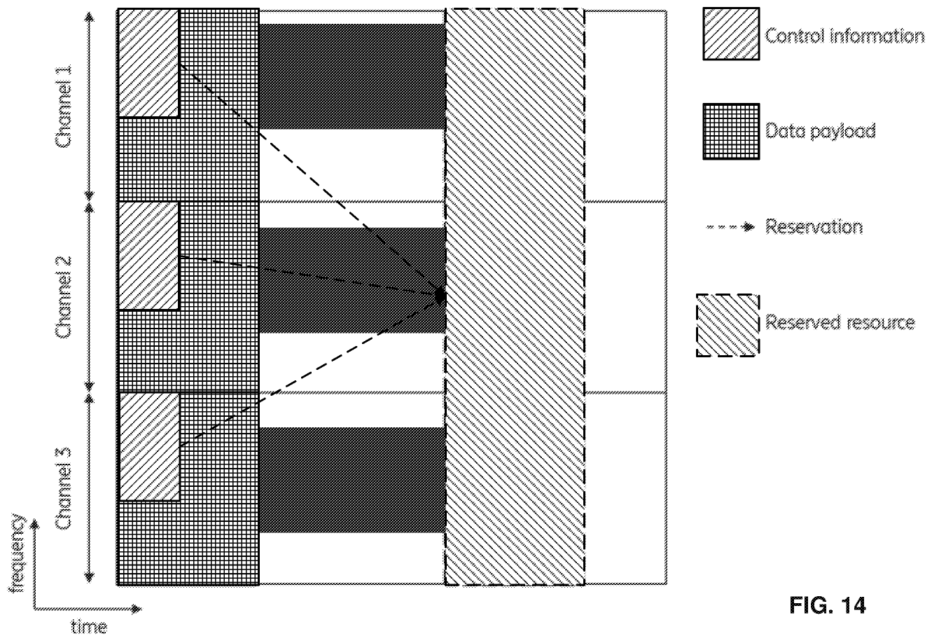

In some embodiments, control information transmitted in a particular channel only carries reservation of resources in that same channel. FIG. 12 shows another exemplary time-frequency grid for SL communication in three channels (labelled 1-3), according to these embodiments. In this arrangement, control information transmitted in Channel 1 reserves resources for subsequent transmission in Channel 1, control information transmitted in Channel 2 reserves resources for subsequent transmission in Channel 2, etc.

In other embodiments, control information transmitted in a particular channel carries reservation of resources in the same channel and in one or more other channels. Different variants of these embodiments are described below.

In some variants, control information transmitted in a particular channel carries reservation of resources in all or a subset of the channels. However, the respective control information will reserve different resources within the multiple channels.

FIG. 13 shows an exemplary time-frequency grid for SL communication in three channels (labelled 1-3), according to these variants. In this arrangement, control information transmitted in Channel 1 reserves resources for subsequent transmission in Channels 1-3, control information transmitted in Channel 2 reserves resources for subsequent transmission in Channels 1-3, etc. In this example, the control information transmitted in each channel carries separate and/or distinct resource reservations for multiple channel. As an example of subset variants, the control information transmitted in one of the channels reserves resources for subsequent transmissions in the same channel and in a single one of the other two channels.

FIG. 14 shows another exemplary time-frequency grid for SL communication in three channels (labelled 1-3), according to these variants. In this arrangement, control information transmitted in Channel 1 reserves resources for subsequent transmission in Channels 1-3, control information transmitted in Channel 2 reserves resources for subsequent transmission in Channels 1-3, etc. In this example, the control information transmitted in each channel carries a single resource reservation for multiple channels.

The main difference between the example shown in FIG. 13 and the example shown in FIG. 14 is whether the resources in the respective channel are reserved separately (as in FIG. 13) or jointly (FIG. 14). Put differently, the examples differ in whether the plurality of channels are treated as an aggregation of separate carriers or as a unitary (e.g., wideband) channel.

In other variants, control information transmitted in a first channel (e.g., main channel, starting channel, channel with a lowest/highest frequency, etc.) carries reservation of resources in all of the channels, while control information transmitted in a second channel (i.e., not the first channel) carries reservation of resources in only a subset of the channels. FIG. 15 shows another exemplary time-frequency grid for SL communication in three channels (labelled 1-3), according to these variants. In this arrangement, control information transmitted in Channel 1 reserves resources for subsequent transmission in all channels, whereas control information transmitted in Channel 2 or 3 reserves resources for subsequent transmission in the same channel. As another example (not shown), the control information transmitted in Channel 2 or 3 reserves resources for subsequent transmission in the same channel and in a single one of the other two channels.

Other embodiments include techniques for a SL receiver UE to process control information received in multiple channels, such as control information transmitted according to any of the embodiments described above.

In some embodiments, the SL receiver UE processes control information received in one of the channels and ignores control information received in other of the channels. For example, the SL receiver UE may process first SCI received in a first channel (e.g., a main channel, a starting channel, a channel with a lowest/highest frequency, etc.) and ignore second SCI received in a second channel (i.e., different than the first channel).

In some embodiments, the SL receiver UE stops processing transmissions for which it receives control information indicating that the transmission spans the UE's supported receive bandwidth (e.g., to which it is currently listening).

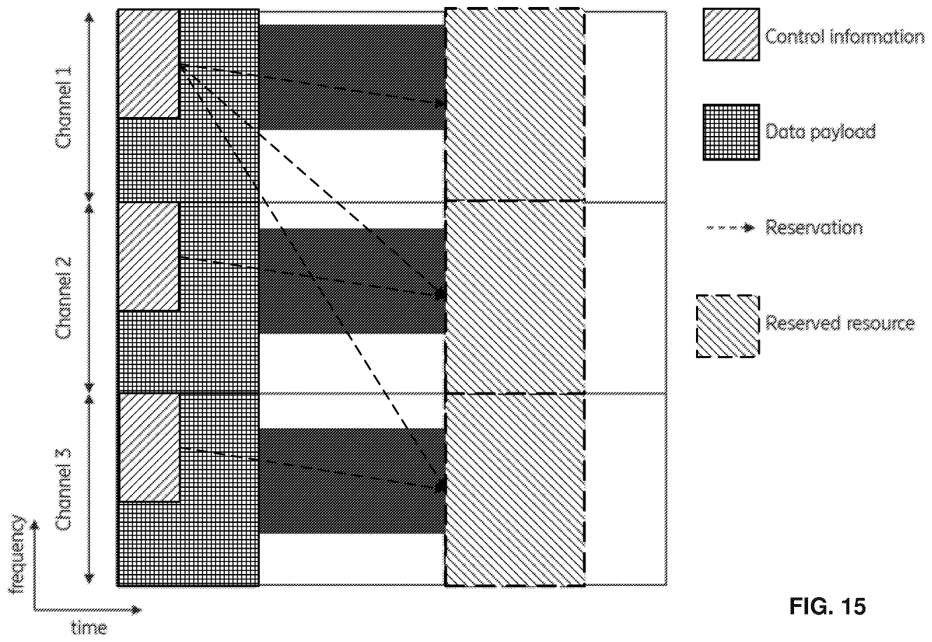

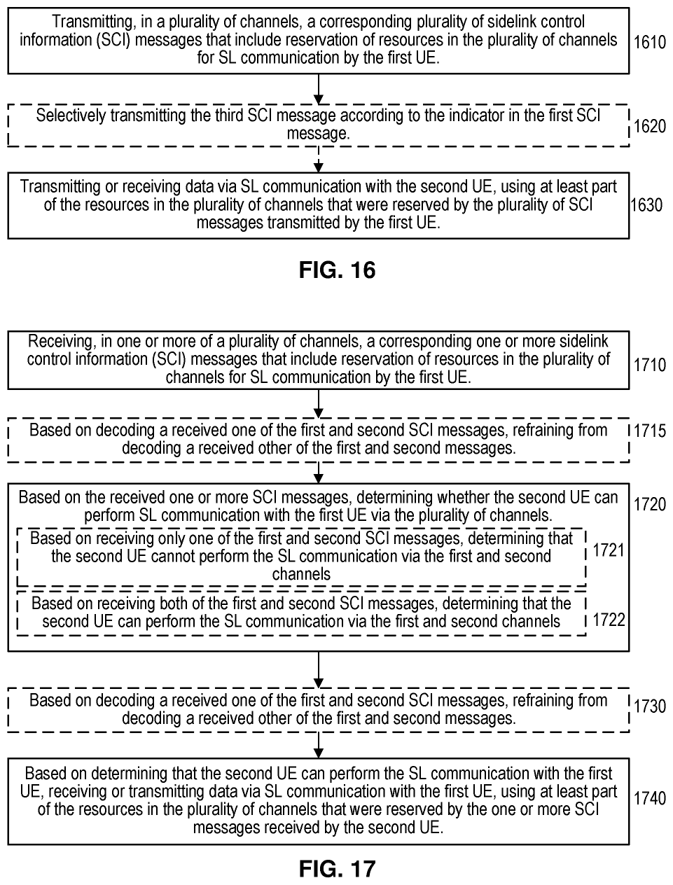

Various features of the embodiments described above correspond to various operations illustrated in FIGS. 16-17, which show exemplary methods (e.g., procedures) for a first UE and a second UE, respectively. In other words, various features of the operations described below correspond to various embodiments described above. Furthermore, the exemplary methods shown in FIGS. 16-17 can be used cooperatively to provide various benefits, advantages, and/or solutions to problems described herein. Although FIGS. 16-17 show specific blocks in particular orders, the operations of the exemplary methods can be performed in different orders than shown and can be combined and/or divided into blocks having different functionality than shown. Optional blocks or operations are indicated by dashed lines.

In particular, FIG. 16 shows an exemplary method (e.g., procedure) for a first UE configured for SL communication with at least a first UE via a plurality of channels, according to various embodiments of the present disclosure. The exemplary method can be performed by a UE (e.g., wireless device) such as described elsewhere herein.

The exemplary method can include the operations of block 1610, where the first UE can transmit, in the plurality of channels, a corresponding plurality of SCI messages that include reservation of resources in the plurality of channels for SL communication by the first UE. The exemplary method can also include the operations of block 1630, where the first UE can transmit or receive data via SL communication with the second UE, using at least part of the resources in the plurality of channels that were reserved by the plurality of SCI messages transmitted by the first UE.

In some embodiments, the plurality of SCI messages include a first SCI message transmitted in a first channel that includes a reservation of resources in the first channel and a second SCI message transmitted in a second channel that includes a reservation of resources in the second channel. For example, the first and second SCI messages can be first stage SCI messages, such as discussed above. In some of these embodiments, the first and second SCI messages have same format (e.g., 1 or 1A).

In some of these embodiments, the first SCI message includes an indicator of whether a third SCI message is also transmitted in the first channel. Unlike the first and second messages, the third SCI message does not include a reservation of resources for SL communication by the first UE. In addition, the exemplary method also includes the operations of block 1620, where the first UE can selectively transmit the third SCI message according to the indicator in the first SCI message. In some variants, the third SCI message includes a scheduling assignment for the second UE when the indicator indicates that third SCI message is transmitted, while the first SCI message includes the scheduling assignment for the second UE when the indicator indicates that third SCI message is not transmitted.

In some of these embodiments, the resources reserved by the first SCI message are only in the first channel and the resources reserved by the second SCI message are only in the second channel. FIGS. 11-12 show examples of these embodiments. In the example shown in FIG. 11, the third SCI is an example of the second SCI message.

In other of these embodiments, the resources reserved by the first SCI message are in the plurality of channels and the resources reserved by the second SCI message are only in the second channel. FIG. 15 shows an example of these embodiments.

In other of these embodiments, the resources reserved by the first SCI message are in the plurality of channels and the resources reserved by the second SCI message are in the plurality of channels. FIGS. 13-14 show examples of these embodiments.

In other of these embodiments, the plurality of channels also include a third channel, the resources reserved by the first SCI message are in the first and third channels but not the second channel, and the resources reserved by the second SCI message are in the second and third channels but not the first channel.

In some embodiments, the reservation of resources is for one or more of the following associated with a transport block (TB) of data: initial transmission by the first UE, blind retransmission or repetition by the first UE, hybrid ARQ-based retransmission by the first UE, and reception from the second UE. FIG. 8 shows some examples of these reservations.

In addition, FIG. 17 shows an exemplary method (e.g., procedure) for a second UE configured for SL communication with at least a first UE via a plurality of channels, according to various embodiments of the present disclosure. The exemplary method can be performed by a UE (e.g., wireless device) such as described elsewhere herein.

The exemplary method can include the operations of block 1710, where the second UE can receive, in one or more of the plurality of channels, a corresponding one or more SCI messages that include reservation of resources in the plurality of channels for SL communication by the first UE. The exemplary method can also include the operations of block 1720, where based on the received one or more SCI messages, the second UE can determine whether it (i.e., the second UE) can perform SL communication with the first UE via the corresponding one or more channels. The exemplary method can also include the operations of block 1740, where based on determining that the second UE can perform the SL communication with the first UE, the second UE can receive or transmit data via SL communication with the first UE, using at least part of the resources in the plurality of channels that were reserved by the one or more SCI messages.

In some embodiments, the one or more SCI messages received by the second UE include one or more of the following transmitted by the first UE: a first SCI message in a first channel that includes a reservation of resources in the first channel; and a second SCI message in a second channel that includes a reservation of resources in the second channel. For example, the first and second SCI messages can be first stage SCI messages, such as discussed above. In some of these embodiments, the first and second SCI messages have same format (e.g., 1 or 1A).

In some of these embodiments, determining whether the second UE can perform the SL communication with the first UE via the plurality of channels in block 1720 can include the following operations, with corresponding sub-block numbers in parentheses:
(1721) based on receiving only one of the first and second SCI messages, determining that the second UE cannot perform the SL communication via the first and second channels; and
(1722) based on receiving both of the first and second SCI messages, determining that the second UE can perform the SL communication via the first and second channels.

In some of these embodiments, the exemplary method can also include the operations of block 1730, where based on decoding a received one of the first and second SCI messages, the second UE can refrain from decoding a received other of the first and second messages.

In some of these embodiments, the first SCI message includes an indicator of whether a third SCI message is also transmitted in the first channel. Unlike the first and second messages, the third SCI message does not include a reservation of resources for SL communication by the first UE. In addition, the exemplary method also includes the operations of block 1715, where the second UE can selectively receive the third SCI message according to the indicator in the first SCI message. In some variants, the third SCI message includes a scheduling assignment for the second UE when the indicator indicates that third SCI message is transmitted, while the first SCI message includes the scheduling assignment for the second UE when the indicator indicates that third SCI message is not transmitted.

In some of these embodiments, the resources reserved by the first SCI message are only in the first channel and the resources reserved by the second SCI message are only in the second channel. FIGS. 11-12 show examples of these embodiments. In the example shown in FIG. 11, the third SCI is an example of the second SCI message.

In other of these embodiments, the resources reserved by the first SCI message are in the plurality of channels and the resources reserved by the second SCI message are only in the second channel. FIG. 15 shows an example of these embodiments.

In other of these embodiments, the resources reserved by the first SCI message are in the plurality of channels and the resources reserved by the second SCI message are in the plurality of channels. FIGS. 13-14 show examples of these embodiments.

In other of these embodiments, the plurality of channels also include a third channel, the resources reserved by the first SCI message are in the first and third channels but not the second channel, and the resources reserved by the second SCI message are in the second and third channels but not the first channel.

In some embodiments, the reservation of resources is for one or more of the following associated with a TB of data: initial transmission by the first UE, blind retransmission or repetition by the first UE, hybrid ARQ-based retransmission by the first UE, and transmission by the second UE. FIG. 8 shows some examples of these reservations.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

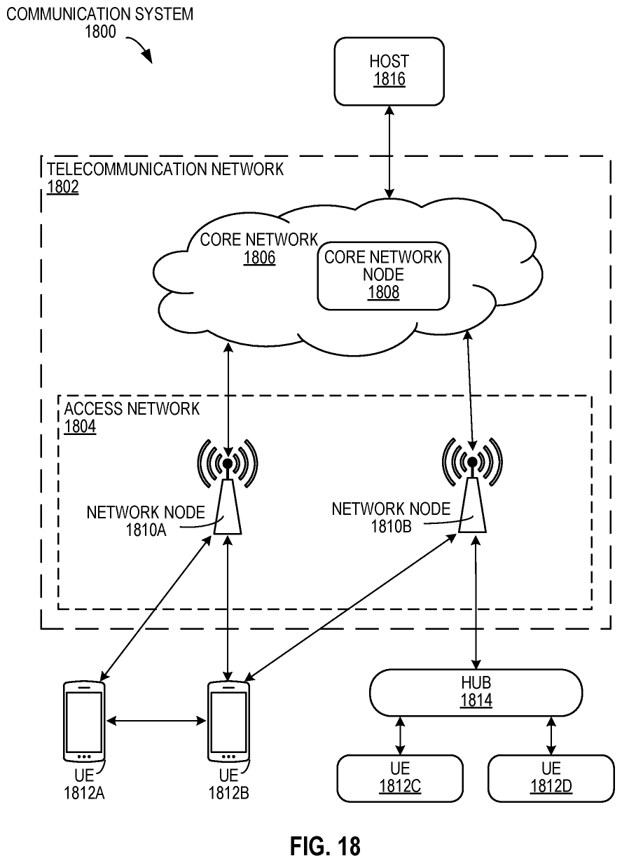

FIG. 18 shows an example communication system 1800 in accordance with some embodiments. In this example, communication system 1800 includes a telecommunication network 1802 that includes an access network 1804 (e.g., RAN) and a core network 1806, which includes one or more core network nodes 1808. Access network 1804 includes one or more access network nodes, such as network nodes 1810a-b (one or more of which may be generally referred to as network nodes 1810), or any other similar 3GPP access node or non-3GPP access point. Network nodes 1810 facilitate direct or indirect connection of UEs, such as by connecting UEs 1812a-d (one or more of which may be generally referred to as UEs 1812) to core network 1806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1800 may include any number of wired or wireless networks, network nodes, UEs, and/or any other components or systems that may facilitate or participate in the communication of data and/or signals whether via wired or wireless connections. Communication system 1800 may include and/or interface with any type of communication, telecommunication, data, cellular, radio network, and/or other similar type of system.

UEs 1812 may be any of a wide variety of communication devices, including wireless devices arranged, configured, and/or operable to communicate wirelessly with network nodes 1810 and other communication devices. Similarly, network nodes 1810 are arranged, capable, configured, and/or operable to communicate directly or indirectly with UEs 1812 and/or with other network nodes or equipment in telecommunication network 1802 to enable and/or provide network access, such as wireless network access, and/or to perform other functions, such as administration in telecommunication network 1802.

In the depicted example, core network 1806 connects network nodes 1810 to one or more hosts, such as host 1816. These connections may be direct or indirect via one or more intermediary networks or devices. In other examples, network nodes may be directly coupled to hosts. Core network 1806 includes one more core network nodes (e.g., core network node 1808) that are structured with hardware and software components. Features of these components may be substantially similar to those described with respect to the UEs, network nodes, and/or hosts, such that the descriptions thereof are generally applicable to the corresponding components of core network node 1808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1816 may be under the ownership or control of a service provider other than an operator or provider of access network 1804 and/or telecommunication network 1802, and may be operated by the service provider or on behalf of the service provider. Host 1816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1800 of FIG. 18 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1802 is a cellular network that implements 3GPP standardized features. Accordingly, telecommunication network 1802 may support network slicing to provide different logical networks to different devices that are connected to telecommunication network 1802. For example, telecommunication network 1802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1812 are configured to transmit and/or receive information without direct human interaction. For instance, a UE may be designed to transmit information to access network 1804 on a predetermined schedule, when triggered by an internal or external event, or in response to requests from access network 1804. Additionally, a UE may be configured for operating in single-or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio—Dual Connectivity (EN-DC).

In the example, hub 1814 communicates with access network 1804 to facilitate indirect communication between one or more UEs (e.g., UE 1812c and/or 1812d) and network nodes (e.g., network node 1810b). In some examples, hub 1814 may be a controller, router, content source and analytics, or any of the other communication devices described herein regarding UEs. For example, hub 1814 may be a broadband router enabling access to core network 1806 for the UEs. As another example, hub 1814 may be a controller that sends commands or instructions to one or more actuators in the UEs. Commands or instructions may be received from the UEs, network nodes 1810, or by executable code, script, process, or other instructions in hub 1814. As another example, hub 1814 may be a data collector that acts as temporary storage for UE data and, in some embodiments, may perform analysis or other processing of the data. As another example, hub 1814 may be a content source. For example, for a UE that is a VR headset, display, loudspeaker or other media delivery device, hub 1814 may retrieve VR assets, video, audio, or other media or data related to sensory information via a network node, which hub 1814 then provides to the UE either directly, after performing local processing, and/or after adding additional local content. In still another example, hub 1814 acts as a proxy server or orchestrator for the UEs, in particular in if one or more of the UEs are low energy IoT devices.

Hub 1814 may have a constant/persistent or intermittent connection to network node 1810b. Hub 1814 may also allow for a different communication scheme and/or schedule between hub 1814 and UEs (e.g., UE 1812c and/or 1812d), and between hub 1814 and core network 1806. In other examples, hub 1814 is connected to core network 1806 and/or one or more UEs via a wired connection. Moreover, hub 1814 may be configured to connect to an M2M service provider over access network 1804 and/or to another UE over a direct connection. In some scenarios, UEs may establish a wireless connection with network nodes 1810 while still connected via hub 1814 via a wired or wireless connection. In some embodiments, hub 1814 may be a dedicated hub—that is, a hub whose primary function is to route communications to/from the UEs from/to network node 1810b. In other embodiments, hub 1814 may be a non-dedicated hub—that is, a device which is capable of operating to route communications between the UEs and network node 1810b, but which is additionally capable of operating as a communication start and/or end point for certain data channels.

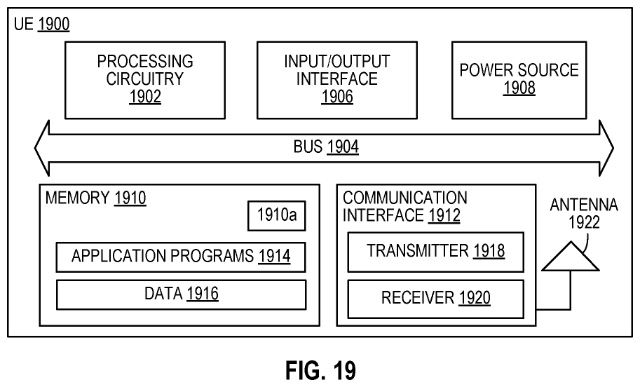

FIG. 19 shows a UE 1900 in accordance with some embodiments. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1900 includes processing circuitry 1902 that is operatively coupled via a bus 1904 to an input/output interface 1906, a power source 1908, a memory 1910, a communication interface 1912, and/or any other component, or any combination thereof. Certain UEs may utilize all or a subset of the components shown in FIG. 19. The level of integration between the components may vary from one UE to another UE. Further, certain UEs may contain multiple instances of a component, such as multiple processors, memories, transceivers, transmitters, receivers, etc.

Processing circuitry 1902 is configured to process instructions and data and may be configured to implement any sequential state machine operative to execute instructions stored as machine-readable computer programs in memory 1910. Such computer programs may be stored in the form of computer program product 1910a, which can include instructions for which execution configures the UE to perform operations corresponding to various exemplary methods described herein.

Processing circuitry 1902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1902 may include multiple central processing units (CPUs).

In the example, input/output interface 1906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1908 is structured as a battery or battery pack. Other types of power sources, such as an external power source (e.g., an electricity outlet), photovoltaic device, or power cell, may be used. Power source 1908 may further include power circuitry for delivering power from power source 1908 itself, and/or an external power source, to the various parts of UE 1900 via input circuitry or an interface such as an electrical power cable. Delivering power may be, for example, for charging of power source 1908. Power circuitry may perform any formatting, converting, or other modification to the power from power source 1908 to make the power suitable for the respective components of UE 1900 to which power is supplied.

Memory 1910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1910 includes one or more application programs 1914, such as an operating system, web browser application, a widget, gadget engine, or other application, and corresponding data 1916. Memory 1910 may store, for use by UE 1900, any of a variety of various operating systems or combinations of operating systems.

Memory 1910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1910 may allow UE 1900 to access instructions, application programs and the like, stored on transitory or non- transitory memory media, to off-load data, or to upload data. An article of manufacture, such as one utilizing a communication system may be tangibly embodied as or in memory 1910, which may be or comprise a device-readable storage medium.

Processing circuitry 1902 may be configured to communicate with an access network or other network using communication interface 1912. Communication interface 1912 may comprise one or more communication subsystems and may include or be communicatively coupled to an antenna 1922. Communication interface 1912 may include one or more transceivers used to communicate, such as by communicating with one or more remote transceivers of another device capable of wireless communication (e.g., another UE or a network node in an access network). Each transceiver may include a transmitter 1918 and/or a receiver 1920 appropriate to provide network communications (e.g., optical, electrical, frequency allocations, and so forth). Moreover, transmitter 1918 and receiver 1920 may be coupled to one or more antennas (e.g., 1922) and may share circuit components, software or firmware, or alternatively be implemented separately.

In the illustrated embodiment, communication functions of communication interface 1912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1912, via a wireless connection to a network node. Data captured by sensors of a UE can be communicated through a wireless connection to a network node via another UE. The output may be periodic (e.g., once every 19 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1900 shown in FIG. 19.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the present disclosure also include, but are not limited to, the following enumerated examples.
A1. A method for a first user equipment (UE) configured for wireless sidelink (SL) communication with at least a second UE via a wideband channel comprising a plurality of channels, the method comprising:
   transmitting, in the plurality of channels, a corresponding plurality of sidelink control information (SCI) messages that include reservation of resources in the wideband channel for SL communication by the first UE; and
   transmitting or receiving data via SL communication with the second UE, using at least part of the resources in the wideband channel that were reserved by the plurality of SCI messages.
A2. The method of embodiment A1, wherein the plurality of SCI messages include:
   a first SCI message transmitted in a first channel that includes a reservation of resources in the first channel; and
   a second SCI message transmitted in a second channel that includes a reservation of resources in the second channel.
A3. The method of embodiment A2, wherein the first and second SCI messages have same format.
A4. The method of any of embodiments A2-A3, wherein:
   the first SCI message includes an indicator of whether a third SCI message is also transmitted in the first channel;
   the third SCI message does not include a reservation of resources for SL communication by the first UE; and
   the method further comprises selectively transmitting the third SCI message according to the indicator in the first SCI message.
A5. The method of embodiment A4, wherein:
   the third SCI message includes a scheduling assignment for the second UE, when the indicator indicates that third SCI message is transmitted; and
   the first SCI message includes the scheduling assignment for the second UE, when the indicator indicates that third SCI message is not transmitted.
A6. The method of any of embodiments A2-A5, wherein the resources reserved by the first SCI message are only in the first channel and the resources reserved by the second SCI message are only in the second channel.
A7. The method of any of embodiments A2-A5,wherein the resources reserved by the first SCI message are in the plurality of channels and the resources reserved by the second SCI message are only in the second channel.
A8. The method of any of embodiments A2-A5, wherein the resources reserved by the first SCI message are in the plurality of channels and the resources reserved by the second SCI message are in the plurality of channels.
A9. The method of any of embodiments A2-A5, wherein:
   the plurality of channels also include a third channel;
   the resources reserved by the first SCI message are in the first and third channels but not the second channel; and
   the resources reserved by the second SCI message are in the second and third channels but not the first channel.
A10. The method of any of embodiments A1-A9, wherein the reservation of resources is for one or more of the following associated with a transport block (TB) of data: initial transmission by the first UE, blind retransmission or repetition by the first UE, hybrid ARQ-based retransmission by the first UE, and reception from the second UE.
B1. A method for a second user equipment (UE) configured for wireless sidelink (SL) communication with at least a first UE via a wideband channel comprising a plurality of channels, the method comprising:
receiving, in one or more of the plurality of channels, a corresponding one or more sidelink control information (SCI) messages that include reservation of resources in the wideband channel for SL communication by the first UE;
based on the received one or more SCI messages, determining whether the second UE can perform the SL communication with the first UE via the corresponding one or more channels; and
   based on determining that the second UE can perform the SL communication with the first UE, receiving or transmitting data via SL communication with the first UE, using at least part of the resources in the wideband channel that were reserved by the one or more SCI messages.
B2. The method of embodiment B1, wherein the one or more SCI messages received by the second UE include one or more of the following transmitted by the first UE:
   a first SCI message in a first channel that includes a reservation of resources in the first channel; and
   a second SCI message in a second channel that includes a reservation of resources in the second channel.
B2a. The method of embodiment B2, wherein determining whether the second UE can perform the SL communication with the first UE via the corresponding one or more channels comprises:
   based on receiving either the first SCI message or the second SCI message, determining that the second UE cannot perform the SL communication via the first and second channels; and
   based on receiving both the first SCI message and the second SCI message, determining that the second UE can perform the SL communication via the first and second channels.
B2b. The method of embodiment B2, further comprising, based on decoding a received one of the first and second SCI messages, refraining from decoding a received other of the first and second messages.
B3. The method of any of embodiments B2-B2b, wherein the first and second SCI messages have same format.
B4. The method of any of embodiments B2-B3, wherein:
   the first SCI message includes an indicator of whether a third SCI message is also transmitted in the first channel;
   the third SCI message does not include a reservation of resources for SL communication by the first UE; and
   the method further comprises selectively receiving the third SCI message according to the indicator in the first SCI message.
B5. The method of embodiment B4, wherein:
   the third SCI message includes a scheduling assignment for the second UE, when the indicator indicates that third SCI message is transmitted; and
   the first SCI message includes the scheduling assignment for the second UE, when the indicator indicates that third SCI message is not transmitted.
B6. The method of any of embodiments B1-B5, wherein the resources reserved by the first SCI message are only in the first channel and the resources reserved by the second SCI message are only in the second channel.
B7. The method of any of embodiments B1-B5, wherein the resources reserved by the first SCI message are in the plurality of channels and the resources reserved by the second SCI message are only in the second channel.
B8. The method of any of embodiments B1-B5, wherein the resources reserved by the first SCI message are in the plurality of channels and the resources reserved by the second SCI message are in the plurality of channels.
B9. The method of any of embodiments B1-B5, wherein:
   the plurality of channels also include a third channel;
   the resources reserved by the first SCI message are in the first and third channels but not the second channel; and
   the resources reserved by the second SCI message are in the second and third channels but not the first channel.
B10. The method of any of embodiments B1-B9, wherein the reservation of resources is for one or more of the following associated with a transport block (TB) of data: initial transmission by the first UE, blind retransmission or repetition by the first UE, hybrid ARQ-based retransmission by the first UE, and transmission by the second UE.
C1. A first user equipment (UE) configured for wireless sidelink (SL) communication with at least a second UE via a wideband channel comprising a plurality of channels, the first UE comprising:
   communication interface circuitry configured to communicate with at least the second UE; and
   processing circuitry operatively coupled to the communication interface circuitry, whereby the processing circuitry and the communication interface circuitry are configured to perform operations corresponding to any of the methods of embodiments A1-A10.
C2. A first user equipment (UE) configured for wireless sidelink (SL) communication with at least a second UE via a wideband channel comprising a plurality of channels, the first UE being further configured to perform operations corresponding to any of the methods of embodiments A1-A10.
C3. A non-transitory, computer-readable medium storing computer-executable instructions that, when executed by processing circuitry of a first user equipment (UE) configured for wireless sidelink (SL) communication with at least a second UE via a wideband channel comprising a plurality of channels, configure the first UE to perform operations corresponding to any of the methods of embodiments A1-A10.
C4. A computer program product comprising computer-executable instructions that, when executed by processing circuitry of a first user equipment (UE) configured for wireless sidelink (SL) communication with at least a second UE via a wideband channel comprising a plurality of channels, configure the first UE to perform operations corresponding to any of the methods of embodiments A1-A10.
D1. A second user equipment (UE) configured for wireless sidelink (SL) communication with at least a first UE via a wideband channel comprising a plurality of channels, the second UE comprising:
   communication interface circuitry configured to communicate with at least the first UE and a RAN node; and
   processing circuitry operatively coupled to the communication interface circuitry, whereby the processing circuitry and the communication interface circuitry are configured to perform operations corresponding to any of the methods of embodiments B1-B10.
D2. A second user equipment (UE) configured for wireless sidelink (SL) communication with at least a first UE via a wideband channel comprising a plurality of channels, the second UE being further configured to perform operations corresponding to any of the methods of embodiments B1-B10.
D3. A non-transitory, computer-readable medium storing computer-executable instructions that, when executed by processing circuitry of a second user equipment (UE) configured for wireless sidelink (SL) communication with at least a first UE via a wideband channel comprising a plurality of channels, configure the second UE to perform operations corresponding to any of the methods of embodiments B1-B10.
D4. A computer program product comprising computer-executable instructions that, when executed by processing circuitry of a second user equipment (UE) configured for wireless sidelink (SL) communication with at least a first UE via a wideband channel comprising a plurality of channels, configure the second UE to perform operations corresponding to any of the methods of embodiments B1-B10.

1. A method for a first user equipment, UE, configured for sidelink, SL, communication with at least a second UE via a plurality of channels, the method comprising:
transmitting, in the plurality of channels, a corresponding plurality of sidelink control information, SCI, messages that include reservation of resources in the plurality of channels for SL communication by the first UE;
transmitting or receiving data via SL communication with the second UE, using at least part of the resources in the plurality of channels that were reserved by the plurality of SCI messages transmitted by the first UE;
the plurality of SCI messages including:
a first SCI message transmitted in a first channel that includes a reservation of resources in the first channel; and
a second SCI message transmitted in a second channel that includes a reservation of resources in the second channel;
the first SCI message includes an indicator of whether a third SCI message is also transmitted in the first channel;
the third SCI message does not include a reservation of resources for SL communication by the first UE; and
selectively transmitting the third SCI message according to the indicator in the first SCI message.

2. (canceled)

3. The method of claim 1, wherein the first and second SCI messages have same format.

4. (canceled)

5. The method of claim 1, wherein:
the third SCI message includes a scheduling assignment for the second UE, when the indicator indicates that third SCI message is transmitted; and
the first SCI message includes the scheduling assignment for the second UE, when the indicator indicates that third SCI message is not transmitted.

6. The method of claim 1, wherein the resources reserved by the first SCI message are only in the first channel and the resources reserved by the second SCI message are only in the second channel.

7. The method of claim 1, wherein the resources reserved by the first SCI message are in the plurality of channels and the resources reserved by the second SCI message are in one of the following: only the second channel, or a subset of the plurality of channels that includes the second channel.

8. The method of claim 1, wherein the resources reserved by the first SCI message are in the plurality of channels and the resources reserved by the second SCI message are in the plurality of channels.

9. The method of 1, wherein:
the plurality of channels also include a third channel;
the resources reserved by the first SCI message are in the first and third channels but not the second channel; and
the resources reserved by the second SCI message are in the second and third channels but not the first channel.

10. The method of claim 1, wherein the reservation of resources is for one or more of the following associated with a transport block, TB, of data: initial transmission by the first UE, blind retransmission or repetition by the first UE, hybrid ARQ-based retransmission by the first UE, and reception from the second UE.

11. A method for a second user equipment, UE, configured for sidelink, SL, communication with at least a first UE via a plurality of channels, the method comprising:
receiving, in one or more of the plurality of channels, a corresponding one or more sidelink control information, SCI, messages that include reservation of resources in the plurality of channels for SL communication by the first UE;
based on the received one or more SCI messages, determining whether the second UE can perform the SL communication with the first UE via the plurality of channels; and
based on determining that the second UE can perform the SL communication with the first UE, receiving or transmitting data via SL communication with the first UE, using at least part of the resources in the plurality of channels that were reserved by the one or more SCI messages received by the second UE;
the one or more SCI messages received by the second UE include one or more of the following transmitted by the first UE:
a first SCI message in a first channel that includes a reservation of resources in the first channel; and
a second SCI message in a second channel that includes a reservation of resources in the second channel;
the first SCI message includes an indicator of whether a third SCI message is also transmitted in the first channel;
the third SCI message does not include a reservation of resources for SL communication by the first UE; and
selectively receiving the third SCI message according to the indicator in the first SCI message.

12. (canceled)

13. The method of claim 11, wherein determining whether the second UE can perform the SL communication with the first UE via the plurality of channels comprises:
based on receiving only one of the first and second SCI messages, determining that the second UE cannot perform the SL communication via the first and second channels; and
based on receiving both of the first and second SCI messages, determining that the second UE can perform the SL communication via the first and second channels.

14. The method of claim 11, further comprising, based on decoding a received one of the first and second SCI messages, refraining from decoding a received other of the first and second messages.

15. The method of claim 11, wherein the first and second SCI messages have same format.

16. (canceled)

17. The method of claim 11, wherein:
the third SCI message includes a scheduling assignment for the second UE, when the indicator indicates that third SCI message is transmitted; and
the first SCI message includes the scheduling assignment for the second UE, when the indicator indicates that third SCI message is not transmitted.

18. The method of claim 11, wherein the resources reserved by the first SCI message are only in the first channel and the resources reserved by the second SCI message are only in the second channel.

19. The method of claim 11, wherein the resources reserved by the first SCI message are in the plurality of channels and the resources reserved by the second SCI message are in one of the following: only the second channel, or a subset of the plurality of channels that includes the second channel.

20. The method of claim 11, wherein the resources reserved by the first SCI message are in the plurality of channels and the resources reserved by the second SCI message are in the plurality of channels.

21. The method of claim 11, wherein:
the plurality of channels also include a third channel;
the resources reserved by the first SCI message are in the first and third channels but not the second channel; and
the resources reserved by the second SCI message are in the second and third channels but not the first channel.

22. The method of claim 11, wherein the reservation of resources is for one or more of the following associated with a transport block, TB, of data: initial transmission by the first UE, blind retransmission or repetition by the first UE, hybrid ARQ-based retransmission by the first UE, and transmission by the second UE.

23. A first user equipment, UE configured for sidelink, SL, communication with at least a second UE via a plurality of channels, the first UE comprising:
communication interface circuitry configured to communicate with at least the second UE; and
processing circuitry operatively coupled to the communication interface circuitry, whereby the processing circuitry and the communication interface circuitry are configured to:
transmit, in the plurality of channels, a corresponding plurality of sidelink control information, SCI, messages that include reservation of resources in the plurality of channels for SL communication by the first UE; and
transmit or receive data via SL communication with the second UE, using at least part of the resources in the plurality of channels that were reserved by the plurality of SCI messages transmitted by the first UE;
the plurality of SCI messages include:
a first SCI message transmitted in a first channel that includes a reservation of resources in the first channel; and
a second SCI message transmitted in a second channel that includes a reservation of resources in the second channel;
the first SCI message includes an indicator of whether a third SCI message is also transmitted in the first channel;
the third SCI message does not include a reservation of resources for SL communication by the first UE; and
selectively transmit the third SCI message according to the indicator in the first SCI message.

24-28. (canceled)

29. A second user equipment, UE configured for sidelink, SL, communication with at least a first UE via a plurality of channels, the second UE comprising:
communication interface circuitry configured to communicate with at least the first UE; and
processing circuitry operatively coupled to the communication interface circuitry, whereby the processing circuitry and the communication interface circuitry are configured to:
receive, in one or more of the plurality of channels, a corresponding one or more sidelink control information, SCI, messages that include reservation of resources in the plurality of channels for SL communication by the first UE;
based on the received one or more SCI messages, determine whether the second UE can perform the SL communication with the first UE via the plurality of channels; and
based on determining that the second UE can perform the SL communication with the first UE, receiving or transmitting data via SL communication with the first UE, using at least part of the resources in the plurality of channels that were reserved by the one or more SCI messages received by the second UE;
the one or more SCI messages received by the second UE include one or more of the following transmitted by the first UE:
a first SCI message in a first channel that includes a reservation of resources in the first channel; and
a second SCI message in a second channel that includes a reservation of resources in the second channel,
the first SCI message includes an indicator of whether a third SCI message is also transmitted in the first channel;
the third SCI message does not include a reservation of resources for SL communication by the first UE; and
selectively receive the third SCI message according to the indicator in the first SCI message.

30-34. (canceled)
